(19) United States
(12) Patent Application Publication
(10) Pub. No.: US 2018/0132454 A1
(43) Pub. Date: May 17, 2018

(54) Play-training device for grabbing or tugging or "spring pole" activities for dogs

(71) Applicant: Federica Giacon, Campodarsego (PD) (IT)

(72) Inventor: Federica Giacon, Campodarsego (PD) (IT)

(21) Appl. No.: 15/739,734

(22) PCT Filed: Jun. 16, 2015
(86) PCT No.: PCT/IB2015/054535

§ 371 Date: Dec. 24, 2017

(30) Foreign Application Priority Data
May 29, 2015 (IT) 102015000014490

(51) Int. Cl. A01K 15/02

(52) U.S. Cl. CPC A01K 15/026

(57) ABSTRACT

A play-training device for grabbing and tugging or “spring pole” activities for dogs includes a single body made entirely of an elastic and flexible material and having a first ring, configured to be grabbed by the dog's mouth, a second ring, to be grasped by a user, and an intermediate joining part of the first ring to the second ring, wherein the intermediate joining part has a length sufficient to create a space between the first ring and the second ring.

The present patent relates to a device for play and conditioning for dogs and in particular concerns a device for grabbing or tugging or “spring pole” activities for dogs.

The new device for dogs was constructed thinking of those people who want to train their dog for “spring pole” activities or grabbing and tugging activities which can be done on the ground or suspended.

In a grabbing activity from the ground, the dog grabs an object in its mouth and pulls it working on all four legs, strengthening the muscles of the front end, such as the flexors and extensors of the forelimb and latissimus dorsi.

In a suspended grabbing activity, the object to be grabbed with the dog's mouth is hung at a given height from the ground, so as to force the dog to jump, grab the object, and remain suspended.

Doing so will strengthen the muscles of the neck and shoulders (latissimus dorsi, trapezius, semitendinosus) and those of the hind legs (gluteus maximus, medius, and minimus muscles, extensor of the leg, adductor and flexor of the thigh).

Normally to engage one's own dog in this activity different materials are needed, such as ropes, springs, tires or other materials, and must be assembled by hand in order to create an amateur version of a “game” that allows the dog to hang while grabbing and pulling a rope/tire etc.

The known art includes devices already on the market comprising a loop of rope in a FIG. 8 shape, that is, forming two substantially equal rings joined at the center, where one ring is grasped by the user and the other ring is grabbed by the dog with its mouth. This device is not elastic and is generally used only for grabbing and tugging activities or play in general.

There are also known devices specifically constructed to be hung, for example, from a branch of a tree or from a fixed support in general, suspended at a specified height from the ground, and comprising a substantially ring-shaped part, suited to be grabbed by the dog's mouth, and a part to be attached to the support.

These devices are usually made in a substantially “homemade” manner, using a cord arranged in the shape of a loop and hung on a hook.

Homemade devices are not elastic and therefore when the dog grabs the ring with its mouth on the fly it risks suffering harmful jerks.

Moreover, these devices cannot be used for grabbing and tugging activities on the ground with a person because they do not have a part for the user to grasp them.

The known art also includes devices, still homemade, comprising a ring or part generally made of rope, intended to be grabbed by the dog's mouth and connected, via a metal spring of suitable strength, to a hook suited to hang the device on a support in general. These devices are typically hand made with pieces of chains, carabiners, and so on. These devices have sufficient elasticity provided by the metal spring, but can be dangerous for the dog that, when jumping, risks biting down on the spring and the metal parts instead of the rope thus injuring teeth and gums, and also risks entangling its legs. This type of device is also not usable for grabbing and tugging activities on the ground with a person.

The known art also includes devices made primarily of elastic material, rubber or nylon, comprising two substantially symmetrical ring-shaped parts, one to be grasped by the person and the other for a dog to grab with its mouth, generally joined a short distance apart by means of a generally flexible part.

These ring-shaped parts are particularly comfortable for the dog and its bite, but this device is not suitable for “spring pole” activities with the device suspended because it cannot be hooked stably to a support in general.

In addition, given the proximity of the two rings and often because the dog jumps so quickly and wildly, the dog might unwittingly bite the hand of the person working with it.

To overcome all the above drawbacks a new type of device for grabbing and tugging or “spring pole” activities for dogs has been developed and constructed.

The main purpose of the present invention is to be able to be used for “spring pole” or grabbing and tugging activities, both suspended and on the ground, guaranteeing maximum safety for the dog and the operator.

One object of the present invention is indeed to ensure the safety of the dog, since the new device is made entirely of rubber without metal parts, has sufficient elasticity such as to dampen the tensile stress, and prevents the biting of dangerous parts by the dog. Another object is to also ensure the safety of the user, since the new device is structured and dimensioned so as to maintain the correct and minimum distance between the operator's hands and the dog's mouth.

Yet another object of the present invention is to be versatile in its use, since it can be used for activities in which the dog grabs it while suspended and also in which the dog bites and pulls from the ground.

One advantage of the present invention is that it is constructed in a single body, without the need for any assembly operation by the user.

Another advantage of the present invention is that it is low cost.

These and other aims, direct and complementary, are achieved by the new device for grabbing or tugging or “spring pole” activities for dogs.

The new device comprises in its main parts a single piece made of a sufficiently elastic and flexible material, such as rubber, in turn comprising a first ring, intended to be grabbed by the dog's mouth, a second ring, intended to be grasped by the user, and at least one part joining the first ring and the second ring.

The part which joins the rings has a length sufficient to create a space between the first ring and the second ring so that the user's hand which grips the second ring is at a safe distance from the mouth of the dog that bites the first ring.

The part which joins the rings preferably has a length of at least 200 mm.

This intermediate part that joins the rings is preferably substantially linear.

In the preferred embodiment the first ring is larger than the second ring.

The new device also comprises preferably at least one through hole or further third ring, for example and preferably made at one end of the part which joins the rings, for example corresponding to or in proximity to the junction between the second ring and the intermediate part.

This hole is suited to directly or indirectly hang the new device to a support in general, preferably fixed, such as to a branch, a setscrew, or another support in general.

This hole may be useful to insert a rope of any length to constrain the new device to a support in general, if the latter is at a height which is too high to hang the device directly. The new device is constructed in a single piece, obtained from a single molding.

The new device is preferably made of non-toxic rubber, and may have a variable hardness and stiffness, depending on the activity to be performed and the type of dog engaging in the activities.

The new device enables a person to conduct grabbing and tugging or “spring pole” activities with a dog which must bite the first ring to then be able to pull it.

This first ring and the part which joins the rings are the elastic part, while the second ring is gripped by the user's hand or the device is constrained to a support by a coupling or hooking means inserted in the through-hole or third ring.

This device can be used for grabbing and tugging activities while suspended, that is, it can be hung at a given height above the ground, higher than that of the dog, which must consequently jump to grab the first ring with its mouth.

Once it has grabbed the first ring, the dog remains engaged and is thus hanging from the device.

The device stretches, dampening the dog's drop back toward the ground.

Being made of rubber and elastic, the new device is not dangerous for the health of the animal since the central cord joining the two rings dampens the tensile stress as the dog grabs and then “drops/yanks” it, preventing damage to the teeth and to the backbone due to the significant stress involved.

The elongation of the device is determined by the size of the first ring and the intermediate portion which joins the two rings, as well as by their elasticity.

Thanks to the through hole or third ring the overall elongation of the device when the tensile stress is applied when the dog is hanging is lower compared to the elongation of the same device if it were hanging just with the second ring.

Therefore it is possible to adjust the maximum elongation obtainable according to the type of activities to be conducted and the weight of the dog.

In fact, an excessive length would require the device to be hung very high, making the exercise dangerous for the dog which, jumping very high, could miss grabbing the ring and fall back to the ground stressing its joints or its body structure in general excessively, or landing improperly or assuming unnatural body positions, with the risk of twists and injuries.

The new device can also be used for grabbing and tugging activities from the ground, that is, with the dog biting the first ring and maintaining its grip by applying tensile stress on the device working with all four paws on the ground.

In this case the device can be grasped by the user by means of the second ring or it can be fixed to a low support.

The new device is therefore useful for the training and conditioning of dogs and especially of the Molosser category of dogs, since it facilitates the development of muscles with brief training.

The characteristics of the new device for grabbing and tugging activities with dogs will be better clarified by the following description with reference to the drawings, attached by way of non-limiting example.

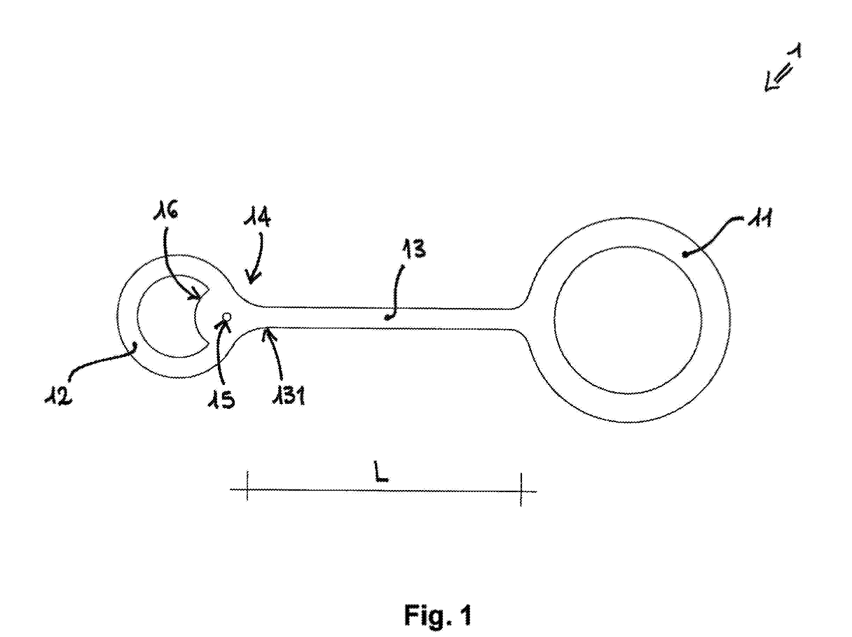

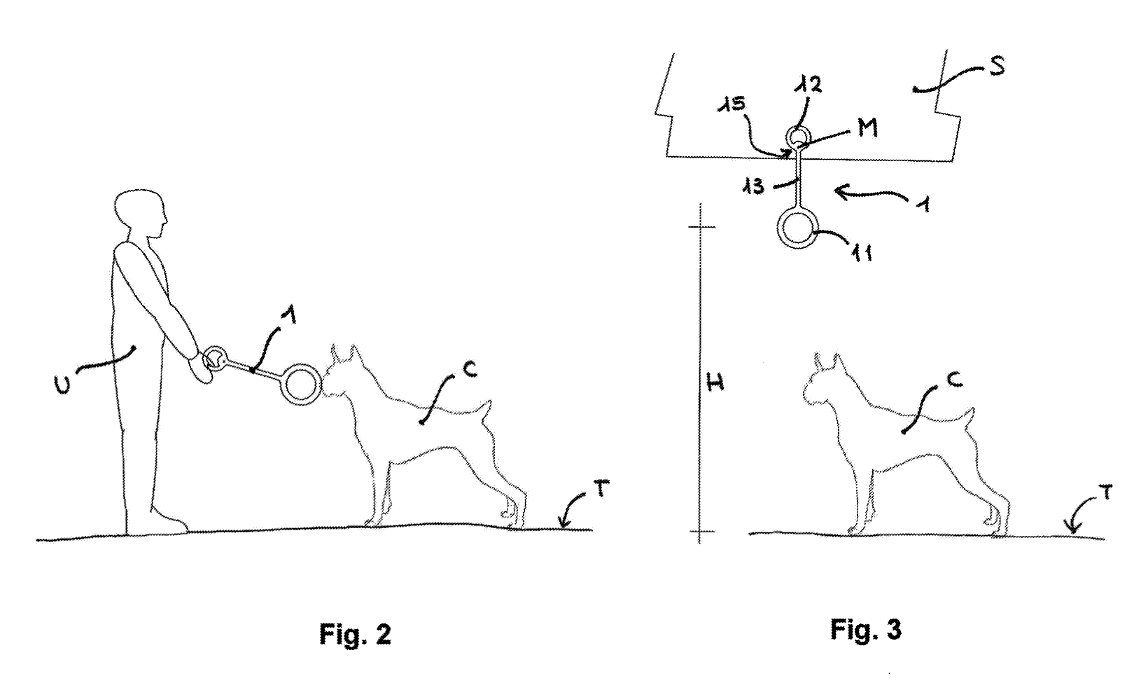

FIG. 1 shows a plan view of the new device (1), while FIGS. 2 and 3 show two of the possible modes of use of the new device (1).

The new device (1) is particularly suited to grabbing and tugging or “spring pole” activities for dogs and comprises a single body with a first ring (11), a second ring (12) spaced from the first ring (11), and a substantially linear intermediate part (13) joining the first and second rings (11, 12).

The first and second ring (11, 12) have a preferably and substantially circular shape and may be the same size or different sizes from each other.

In the preferred embodiment, the first ring (11), intended to be grabbed by the dog with its mouth (C), is larger than the second ring (12), intended to be grasped by the user's hand (U), in the case in which the device (1) is used for activities from the ground, as shown in FIG. 2.

For example, the first ring (11) could have a diameter of about 150-300 mm, while the second ring (12) could have a diameter of 100-200 mm.

The thickness of the first ring (11) could for example be 25-40 mm, while the thickness of the second ring (12) could be 15-30 mm.

The substantially linear intermediate joining part (13) preferably has a length (L) of 200-400 mm and a thickness of 15-40 mm.

The intermediate part (13) performs multiple functions. In particular, since it is made of resilient material, typically rubber, it does not represent a danger for the dog's bite, as it is not likely to injure the teeth, gums and mouth in general.

In addition to this, it is sufficiently elastic so as to resist a given tensile stress generated by the dog, whether it is on the ground or suspended from the device (1) itself, counteracting the lengthening.

This intermediate portion (13) has also a length (L) sufficient to create a space between the first ring (11) and the second ring (12) so as to ensure that the user's hand is not accidentally bitten by the dog.

While conducting these grabbing and tugging activities, the overall elongation of the device is determined by the deformation and elongation of the first and second rings (11, 12) and by lengthening of the intermediate part (13).

In the intermediate part (13), preferably in the area (14) of the junction between the second ring (12) and one end (131) of the intermediate part (13), there is at least one through hole (15) or third ring, this hole (15) having a very small diameter with respect to the first and second rings (11, 12).

For example, this hole (15) has dimensions of 5-20 mm and is suitable for the insertion of means for hooking or fixing the device to a fixed support to conduct grabbing and tugging activities while suspended, as shown in FIG. 3.

In correspondence with this hole (15) there is a thickening (16) which serves to reinforce it, for example substantially circular or a portion of a circle, surrounding the hole (15). This thickening has for example a thickness of 30-70 mm.

During these activities, the device is hung from a support (S), preferably fixed, for example by means of a screw or other means of fastening or hooking or rope (M) inserted in the hole (15) so that the first ring (11) is substantially facing downward and is at a certain height (H) from the ground (T).

The maximum elongation of the device, in this case, is determined by the deformation and elongation of the first ring (11) and by the lengthening of the intermediate part (13), from the first ring (11) and the hole (15), while the remaining part and the second ring (12) are not deformed.

In the case in which the hole (15) is made corresponding to the area (14) of the junction between the second ring (12) and one end (131) of the intermediate part (13) the maximum elongation of the device is determined by the deformation and elongation of the first ring (11) and by the lengthening of the intermediate part (13), while the second ring (12) is not deformed.

These specifications are sufficient for the expert person to make and use the invention, as a result, in the practical application there may be variations without prejudice to the substance of the innovative concept.

Therefore, with reference to the preceding description and the attached drawings the following claims are made.

The invention claimed is:

1.-10. (canceled)

11. A play-training device for grabbing and tugging or “spring pole” activities for dogs, comprising:
a single body made entirely of an elastic and flexible material and having,
a first ring adapted to be grabbed by a mouth of a dog,
a second ring adapted to be grasped by a user, and
an intermediate part joining the first ring to the second ring,
wherein the intermediate part has a length sufficient to create a space between the first ring and the second ring, the intermediate part being elastic so as to counteract a lengthening between the first ring and the second ring, and
where an overall elongation of the play-training device is determined by a deformation and an elongation of the first and the second rings and by the lengthening of the intermediate part.

12. The play-training device according to claim 11, wherein intermediate part has a length of at least 200 mm.

13. The play-training device according to claim 11, wherein the intermediate part is substantially linear.

14. The play-training device according to claim 11, wherein the first ring is larger than the second ring.

15. The play-training device according to claim 11,
further comprising a through hole or a third ring defined in the intermediate part and adapted to receive a fastener, a coupling element, or a rope to directly or indirectly hang the play-training device from a support at a given height from a ground,
wherein the overall elongation of the play-training device hanging from a support by the fastener, a hook, or the rope inserted in the through hole or the third ring is determined by the deformation and the elongation of the first ring and by the lengthening of said intermediate part between the first ring and the through hole or the third ring, while a remaining portion of the intermediate part and the second ring are not deformed.

16. The play-training device according to claim 15, wherein the through hole or the third ring is defined at or in proximity of a junction area between the second ring and the intermediate part, wherein the overall elongation of the play-training device hung from the support is determined by the deformation and the elongation of the first ring and from the elongation of the intermediate part while the second ring is not deformed, and wherein the play-training device further comprises at least one reinforcement thickening around the through hole or the third ring.

17. The play-training device according to claim 11, wherein the play-training device is made of a rubber having a hardness and an elasticity selected based on an activity to be performed and a type of the dog to be engaged in the activity.

18. The play-training device according to claim 11, wherein the first ring has a diameter of 150-300 mm and a thickness of 25-40 mm.

19. The play-training device according to claim 11, wherein the second ring has a diameter of 100-200 mm and a thickness of 15-30 mm.

20. The play-training device according to claim 11, wherein the intermediate part is substantially linear and has a length of 300-400 mm and a thickness of 15-40 mm.
